(19) United States
(12) Patent Application Publication
(10) Pub. No.: US 2025/0139250 A1
(43) Pub. Date: May 1, 2025

(54) MANAGING SECURITY FEATURES OF CONTAINER ENVIRONMENTS

(71) Applicant: Hewlett Packard Enterprise Development LP, Spring, TX (US)

(72) Inventors: Manisha Manjunath, Bangalore (IN); Suhas Shivanna, Houston, TX (US); Anusha Yerranagula, Bangalore (IN); Supriya Kamthania, Bangalore (IN)

(21) Appl. No.: 18/429,564

(22) Filed: Feb. 1, 2024

(30) Foreign Application Priority Data
Oct. 27, 2023 (IN) 202311073378

(51) Int. Cl. G06F 21/57

(52) U.S. Cl. CPC G06F 21/577; G06F 2221/034

(57) ABSTRACT

A process includes determining, by a recommendation engine, a security risk profile for a container environment. The container environment includes a plurality of pods that are to be deployed on an infrastructure that includes a plurality of nodes. Determining the security risk profile includes determining an infrastructure context characterizing the infrastructure and determining a workload context characterizing a workload associated with the container environment. The process includes determining, by the recommendation engine, a recommendation of a security policy for the container environment based on the security risk profile. The security policy includes a security control. The process includes deploying an agent to the infrastructure to manage compliance of the container environment with the security control.

### BACKGROUND

A computer system may be subject to a security attack for such purposes as seeking access to information that is stored on the computer system or harming components of the computer system. To prevent or at least inhibit the degree of potential harm that is inflicted by a security attack, a computer system may have various security features.

### BRIEF DESCRIPTION OF THE DRAWINGS

FIG. 1 is a block diagram of a computer system having central security management services to manage security features of a container environment that is deployed on a remote infrastructure according to an example implementation.

FIG. 2 is a block diagram of a security feature recommendation engine of FIG. 1 according to an example implementation.

FIG. 3 is an illustration of a subsystem of FIG. 1 to manage security features of a container environment according to an example implementation.

FIGS. 4 and 5 are flow diagrams depicting processes to configure and deploy a management agent and a container environment on a remote infrastructure according to example implementations.

FIG. 6 is a process to manage security features of a container environment according to an example implementation.

FIG. 7 is a block diagram of a computer system that includes a management agent and a security enforcement engine to manage compliance of a container environment with a policy that specifies security features according to an example implementation.

FIG. 8 is an illustration of machine-readable instructions that, when executed by a machine, cause the machine to process a management agent-provided compliance report representing whether a container environment complies with a security control and initiate a corrective action responsive to identifying non-compliance of the container environment with the security control, according to an example implementation.

### DETAILED DESCRIPTION

In one type of application architecture, an application may be monolithic and correspond to a single unit. In another type of application architecture, an application may be formed from multiple, autonomous parts called “microservices.” As compared to the monolithic architecture, the microservice architecture provides greater agility, elasticity and greater control for software quality assurance. Moreover, the microservice architecture may be better suited for a cloud deployment of an application.

A microservice may be provided by a container environment. In this context, a “container environment” refers to a collection of one or multiple instantiated containers (also referred to herein as “containers”). For a container environment that includes multiple containers, the containers may collaborate for a particular purpose (e.g., providing a microservice). A container environment may be orchestrated or non-orchestrated (or “self-managed”). An orchestrated container environment has an orchestrator that manages the lifecycles and workloads of the environment's containers. In examples, an orchestrator may manage provisioning and resource allocation for the containers. In other examples, an orchestrator may manage container replication, when containers start and stop, container scaling, workload distribution among the containers, or other lifecycle phase or workload aspects of the container environment. In examples, an orchestrated container environment may have a KUBERNETES orchestrator or a DOCKER SWARM orchestrator.

In an example, an orchestrated container environment may include a cluster of worker nodes (virtual or physical), and each worker node of the cluster may host one or multiple groups of containers, called “container pods.” The lifecycles of the worker nodes may be managed by a control plane of an orchestrator. In an example, an orchestrated container environment (called a “multi-cluster” container environment herein) may include multiple clusters of worker nodes. For example, the multiple clusters may be distributed across infrastructures that are located in different geographical locations, such as, for example, infrastructures that correspond to different data centers.

In another example, a container environment may be a self-managed, or non-orchestrated, environment that includes one or multiple containers and no orchestrator.

A container environment (called a “multi-tenant” container environment) may be associated with multiple tenants. A “tenant” refers to a group of users that share the same access privileges. In an example, multiple departments of an enterprise may correspond to different tenants of a multi-tenant container environment. In another example, the tenants of a multi-tenant container environment may correspond to user groups of unrelated entities.

Properly securing a container environment may be particularly challenging, especially for multi-cluster and/or multi-tenant container environments. For example, for a multi-cluster container environment, the distribution of the clusters across different infrastructures (e.g., distributed across infrastructures associated with different data centers) makes it challenging to have a consistent visibility of all clusters. Although container orchestration technology may provide measures to secure a container environment, proper security measures may not be in place by default when containers of the environment are first deployed, and this omission, even if brief in nature, may create security vulnerabilities. Securing a container environment may also be complicated by its elastic infrastructure and often ephemeral workloads. For example, an orchestrated container environment may be continually scaled up (e.g., container pods are added) and down (e.g., container pods are removed) to accommodate the container environment's changing workload. A malicious, short-lived container pod that is added for a brief time to accommodate an increased workload may escape scheduled security assessments and bring down the container environment. Moreover, due to other factors (e.g., software bugs, software corruption, malevolent actors or oversight), security assessments and security controls for a container environment may not be implemented, removed or modified.

In accordance with example implementations that are described herein, security features for a container environment are managed using central security management services (e.g., cloud-based services) and a management agent. In accordance with example implementations, the management agent is deployed on the same infrastructure as the container environment. In accordance with example implementations, the central security management services include a security enforcement service that communicates with the management agent. More specifically, the management agent, in accordance with example implementations, assesses compliance of the container environment with any of a number of different security policies and sends reports to the security enforcement service, which document any non-compliance(s). The security enforcement service, in accordance with example implementations, may initiate one or multiple actions to counter reported security policy non-compliance. In examples of such actions, the security enforcement service may stop a container pod, stop the entire container environment, reconfigure a container, provide another replacement container image, notify a system administrator, or take one or multiple other actions.

In an example, a security policy may be a security control policy that specifies a list of security controls for the container environment. In this context, “a security control” refers to a feature to restrict access to one or multiple components of the container environment. In an example, a security control policy may, for a given security control, specify one or multiple attributes for the security control, such as specific characteristics of the security control and/or a use case for when the container environment is to use the security control. In a more specific example, a security control policy may specify that the container environment is to use a secure network communication protocol for certain communications (e.g., all external communications or external communications with certain entities). In another example, a security control policy may specify that the container environment is to password protect basic input/output system (BIOS) functions and specify criteria defining aspects of the password and/or the entities that are to use the password. In another example, a security control policy may specify a minimum number of characters for an operating system password. In another example, a security control policy may specify that certain files are not to be executed unless the signatures of the files are verified against corresponding trusted signatures. In another example, a security control policy may limit control plane access for a container orchestrator (e.g., limit control plane access for a KUBERNETES controller manager). In another example, a security control policy may constrain the container environment to a root file system. In another example, a security control policy may constrain application processes to run as root users.

In another example of a security policy, the security policy may be a security assessment policy that specifies a list of security assessment actions that are to be performed by or on the container environment. In this context, “a security assessment action” refers to a specific way, or technique, for security issues with the container environment to be detected, or identified. In examples, a security assessment action may identify a security vulnerability, detect evidence of rogue software component, detect evidence of a security attack, or detect untrusted or unauthorized image or file. In an example, a security assessment policy may specify that a particular monitoring component (e.g., a hypervisor agent, an operating system agent, a container environment orchestrator, a specific pod or other control plane entity) that is associated with the container environment is to scan and evaluate logs of system events that occur in the container environment pursuant to a certain schedule or responsive to the occurrence of certain events. In another example, a security assessment policy may specify that a particular monitoring component is to scan and evaluate container images associated with the container environment when threat intelligence reveals a new container vulnerability. In another example, a security assessment policy may specify that a monitoring component is to scan and evaluate container image(s) associated with the container environment responsive to a certain user-specified action, such as a privileged user login or a certain anomaly event. In another example, a security assessment policy may specify that a monitoring component is to scan a container image to evaluate the container image prior to instantiating the corresponding container.

In another example of a security policy, the security policy may be a remediation policy that specifies a list of remediation actions to be taken by the container environment in the event that a particular security issue occurs. In this context, a “remediation action” refers to an operation to be undertaken to counter or address a particular security issue. In an example, a remediation policy may specify a particular remediation action to be taken by a particular component (e.g., a hypervisor agent, an operating system agent, an orchestrator for the container environment, a specific pod or other control plane component), one or multiple characteristics of the remediation action and one or multiple triggers to initiate the remediation action. In an example, a remediation policy may specify that a certain security vulnerability is to be cured (e.g., the container environment is to be reconfigured via a new configuration file or new container image) within a certain number of days. In another example, a remediation policy may specify that a worker node of the container environment is to be shut down when a specified security issue occurs with a container or container pod that is hosted on the worker node. In another example, a remediation policy may specify that an alert message is to be sent to a system administrator when a specific security issue occurs with the container environment.

In accordance with example implementations, the remote management agent may continually monitor compliance of the container environment with the security policies and send reports (e.g., messages) to the security enforcement service detailing any non-compliances with the security policies. Moreover, in accordance with example implementations, the remote management agent may send reports to the security enforcement service, which contain additional information associated with the container environment. In an example, the remote management agent may send a report that contains data that represents details about the infrastructure that hosts the container environment, such as, in an example, whether the containers are hosted on bare metal computer platforms or in virtual machines. In another example, the remote management agent may send a report that contains data that represents a log of events associated with the container environment. In another example, the remote management agent may send a report that contains data that represents security vulnerabilities that are detected by security assessments that are performed by the container environment. In another example, the remote management agent may send a report that contains data that represents security events that are detected by security assessments that are performed by the container environment.

The security enforcement service, in accordance with example implementations, may, responsive to a report from the remote management agent, initiate one or multiple actions based on a corresponding responsive action policy. In accordance with example implementations, the security enforcement service may be configured with multiple responsive action policies. In an example, a responsive action policy may specify that the security enforcement service is to shut down a node of the container environment in response to a container of the node not implementing a security control (e.g., a security control specifically identified by the responsive action policy). In another example, a responsive action policy may specify that the security enforcement service is to mark a node of the container environment as being unhealthy in response to an identified container image vulnerability being found in a container image associated with the container environment. In another example, the responsive action policy may specify the security enforcement service is to alert a system administrator in response to a particular security vulnerability assessment not being performed by the container environment. In another example, a responsive action policy may specify the security enforcement service is to shut down a node in response to a security control being modified (e.g., the container environment no longer imposes a certain minimum length password) in violation of a security control policy.

In accordance with example implementations, the central security management services include a security feature recommendation service, which recommends security features for a particular container environment that is to be deployed. In an example, the security features may include specific security controls, security assessment actions and security remediation actions for the container environment. In accordance with example implementations, the security feature recommendation service may determine security feature recommendations for a particular container environment by first determining a discretized security risk profile (e.g., a classification of whether the container environment is a high security risk, a medium security risk or a low security risk) for the container environment based on input data that characterizes attributes of the container environment. The determination of the security risk profile may involve the security feature recommendation engine mapping, via rules, the input data to a security risk profile; applying the input data to machine learning classifiers for the security risk profiles; or a combination of rule-based mapping and machine learning-based classification. In accordance with example implementations, the security feature recommendation service recommends a set of security features for the container environment, which correspond to the determined security risk profile. As further described herein, the security feature recommendation service may, in addition to the security risk profile, consider other attributes associated with the container environment in determining the recommendations.

A customer may determine to incorporate some or all of the security features that are recommended by the security feature recommendation service into a container environment to-be-deployed, as well as modify some parameters of the recommended security features and possibly add other security features. The selected security features may be implemented at least in part, in accordance with example implementations, using a deployment service of the central security management services. Moreover, the deployment service, in accordance with example implementations, configures the remote management agent with a set of security policies (e.g., a security control policy, a security assessment policy and a security remediation policy) so that the remote management agent may monitor the container environment, once deployed, and report any non-compliance with the security policies to the security enforcement service.

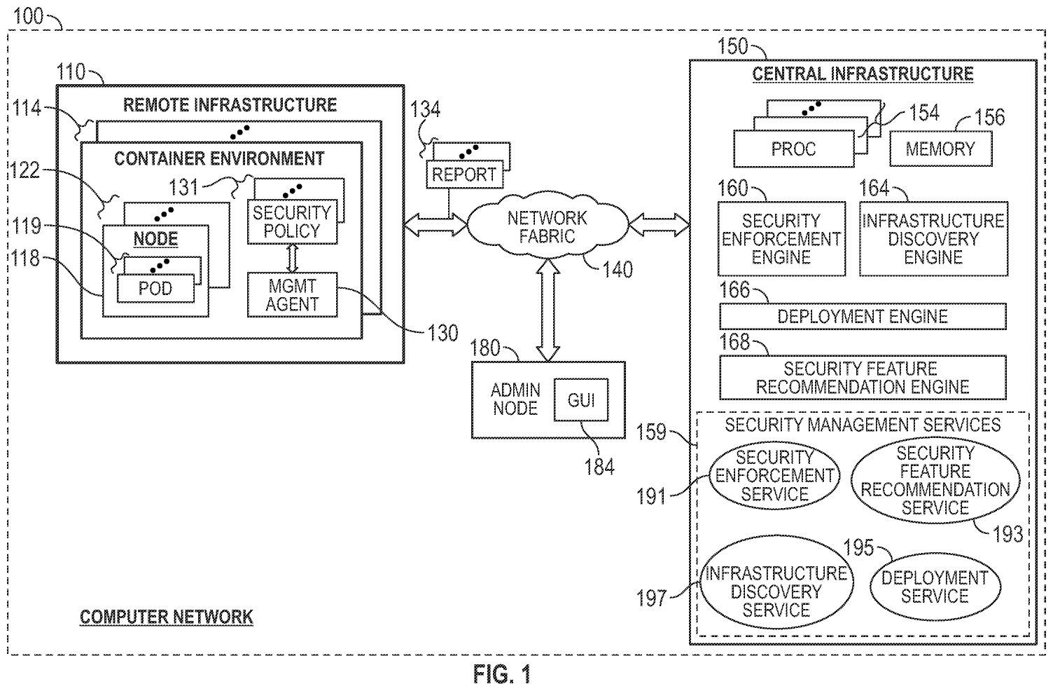

Referring to FIG. 1, as a more specific example, in accordance with some implementations, a computer network 100 includes a central infrastructure 150 that provides one or multiple central security management services 159. The central security management services 159 manages security features of one or multiple container environments 114 that may be deployed on one or multiple remote infrastructures 110.

As used herein, an “infrastructure” refers to a framework that includes a collection of actual, or physical, hardware and software resources. In an example, an infrastructure may include one or multiple processor-based electronic devices, or computer platforms. In examples, a computer platform may be a standalone server; a distributed server; a rack-mounted server module; an edge processing, rack-mounted module; a blade server; a blade enclosure containing one or multiple blade servers; a client; a thin client; a desktop computer; a portable computer; a laptop computer; a notebook computer; a tablet computer; network device; a network switch, a gateway device, a smartphone; a wearable computer; or another processor-based platform. In examples, an infrastructure may be a computer system that corresponds to one or multiple data centers, an enterprise campus, an office building or other system.

In addition to physical resources, in accordance with example implementations, an infrastructure provides one or multiple virtualization technologies, which abstract underlying physical resources to provide virtualized resources. In examples, these virtualized resources may be associated with virtual application operating environments, virtual machines, container environments, virtual networks, virtual storage or other abstractions.

The “remote” and “central” labels for the infrastructures 110 and 150, respectively, reflect that the infrastructures 110 and 150 are associated with different local networks. As depicted in FIG. 1, in accordance with example implementations, network fabric 140 may connect the central infrastructure 150 and the remote infrastructure 110. The network fabric 140 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof. In an example, the remote infrastructure 110 and the central infrastructure 150 may be part of the same WAN (e.g., the Internet).

In an example, the central infrastructure 150 may be cloud-based and may correspond to one or multiple data centers. In an example, the remote infrastructure 110 may be cloud-based (e.g., correspond to a particular data center) and may be affiliated with the same cloud operator as the central infrastructure 150; and the container environment(s) 114 may be associated with a customer of security management services 159 that are provided by the central infrastructure 150. In another example, the central infrastructure 150 may be cloud-based, and the remote infrastructure 110 may correspond to a private computer network of a customer of the security management services 159. In another example, the central infrastructure 150 may not be cloud-based. For example, in accordance with some implementations, the central infrastructure 150 may correspond to a private enterprise computer network.

FIG. 1 depicts an example deployed container environment 114 that includes a cluster of worker nodes 118. Each worker node 118 of the container environment 114 may host one or multiple container pods 119. In an example, the cluster may be an orchestrated cluster that is managed by a container orchestrator (not shown). In another example, a container environment 114 may have a single container. In another example, a container environment 114 may have a single container pod. In another example, a container environment 114 may not have an orchestrator and instead, may include one or multiple self-managed containers. In another example, a container environment 114 may have multiple clusters of worker nodes. In other examples, container environments 114 may have single (for a single tenant container environment 114) or multiple (for a multi-tenant container environment 114) tenants.

As depicted in FIG. 1, in accordance with example implementations, the security management services 159 may include a security enforcement service 191, a security feature recommendation service 193, a deployment service 195 and an infrastructure discovery service 197. The security management services 159 may be managed using one or multiple remote dashboards, or graphical user interfaces (GUIs). FIG. 1 depicts an example administrative node 180 that has an example GUI 184. In an example, the GUI 184 may be an internet browser-based interface. In another example, the GUI 184 may be provided by dedicated software that executes on the administrative node 180. Through the GUI 184, a user (e.g., a software developer or a system administrator) that is associated with a customer of the security management services 159, may manage security features of one or multiple container environments 114.

More specifically, the user may, for a given container environment 114 to be deployed, provide input (called “intent input” herein) to the security feature recommendation service 193 describing an intent for the container environment 114. In the context that is used herein, an “intent” for a container environment 114 to be deployed generally refers to one or multiple goals or objectives for the container environment 114. The security feature recommendation service 193 may determine recommended security features for the container environment 114 based on the intent input and possibly other inputs, such as, for example, input that is provided from the infrastructure discovery service 197 (representing attributes of the remote infrastructure 110) and/or input representing the customer's perceived security risk of the container environment 114. The user may, via the GUI 184, view the security feature recommendations for the container environment 114.

One or multiple of the recommended security features may be added to the container environment 114. In an example, security features may be added via the container environment's container image(s) and/or configuration files. In accordance with some implementations, security features may be added to a container environment 114 via selections made using the deployment service 195. A user may, via the GUI 184, use the deployment service 195 to deploy the container environment 114 on the remote infrastructure 110. As part of the deployment, the user may provide input to the deployment service 195 to select one or multiple security features of the container environment 114, which are to be monitored for compliance. In accordance with example implementations, the deployment service 195 may, responsive to the selection of the security features, generate one or multiple security feature policies 131 that specify security features to be monitored by a remote management agent 130 that is deployed on the remote infrastructure 110. In an example, the security feature policy(ies) 131 may include a security control policy that specifies security controls. In another example, the security feature policy(ies) 131 may include a security assessment policy that specifies certain security assessment actions. In an example, the security feature policy(ies) 131 may include a security remediation policy that specifies security remediation actions.

In accordance with example implementations, the remote management agent 130 is configured to monitor environments of a particular container environment 114 for purposes of determining whether the container environment 114 is complying with the security policy(ies) 131. In an example, the remote management agent 130 may be a component of the container environment 114. In an example, the remote management agent 130 may be a container (e.g., a sidecar pattern container) of the container environment 114. In another example, the remote management agent 130 may be a container pod of the container environment 114. In another example, the remote management agent 130 may be hosted on a worker node 118 of the container environment 114. In another example, the remote management agent 130 may be part of the control plane for the container environment 114. In another example, the remote management agent 130 may correspond to a set of functions that are performed by an orchestrator of the container environment 114. In another example, the remote management agent 130 may be an operating system kernel space entity of the container environment 114. In another example, the remote management agent may be external to the container environment 114 (e.g., a container, container pod or, in general, another container environment).

In accordance with some implementations, the management agent 130 may be deployed concurrently on the remote infrastructure 110 with the container environment 114. In accordance with further implementations, the management agent 130 may be deployed before the container environment 114. In this manner, the management agent 130 may serve another purpose of gathering information about the remote infrastructure 110 on which future container environments 114 are to be deployed.

Regardless of its particular form or architecture or whether the management agent 130 is deployed before or with a particular container environment 114, the management agent 130 monitors compliance of the container environment 114 with the security features of the security feature policy(ies) 131 and sends reports 134 (e.g., messages) to the security enforcement service 191. In an example, a report 134 may contain data representing non-compliance of the container environment 114 with a particular security feature. The security enforcement service 191, responsive to a reported non-compliance, may initiate one or multiple responsive actions to counter the non-compliance. In an example, the security enforcement service 191 may, through the GUI 184 or other mechanism, send an alert message to a system administrator. In another example, the security enforcement service 191 may initiate an action to directly address the non-compliance. In examples, the security enforcement service 191 may mark a worker node 118 as being unhealthy, stop a worker node 118, reconfigure a worker node 118 or container pod 119, or perform one or multiple other actions. Depending on the particular implementation, the security enforcement service's initiation of a particular responsive action may occur automatically without user involvement or may include a user approving or selecting (e.g., approving or selecting via the GUI 184) responsive action(s) that are recommended by the security enforcement service 191.

In the context that is used herein, a “container” (which may also be referred to as “instantiated container,” “container instance, or “software container”) generally refers to a virtual run-time environment for one or multiple applications and/or application modules, and this virtual run-time environment is constructed to interface to an operating system kernel. A container for a given application may, for example, contain the executable code for the application and its dependencies, such as system tools, libraries, configuration files, executables and binaries for the application. In accordance with example implementations, the container contains an operating system kernel mount interface but does not include the operating system kernel. As such, a given computer platform may, for example, contain multiple containers that share an operating system kernel through respective operating system kernel mount interfaces. Docker containers and rkt containers are examples of containers.

In accordance with example implementations, the security management services 159 may be provided by one or multiple engines that are hosted on the central infrastructure 150. In accordance with some implementations, a security enforcement engine 160 provides the security enforcement service 151. In accordance with some implementations, a security feature recommendation engine 168 provides the security feature recommendation service 193. In accordance with some implementations, an infrastructure discovery engine 164 provides the infrastructure discovery service 197. In accordance with some implementations, a deployment engine 166 provides the deployment service 195.

As used herein, an “engine” can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) executable on the one or more hardware processing circuits. Depending on the particular implementation, an engine may be formed solely from a hardware processing circuit that executes machine-executable instructions; formed from a combination of a hardware processing circuit that executes machine-executable instructions and other hardware circuitry that does not execute machine-readable instructions; or formed solely from a hardware circuit that does not execute machine-executable instructions.

In accordance with some implementations, the engines 160, 164, 166 and 168 may be provided by one or multiple hardware processors 154 (e.g., one or multiple central processing unit (CPU) cores, graphical processing units (GPUs) or other processing circuits) of the central infrastructure 150, which executes machine-readable instructions that are stored in a memory 156 of the central infrastructure 150. In accordance with example implementations, the memory 156 may be implemented using a collection of physical memory devices. In general, the memory devices that form the memory 156, as well as other memories and storage media that are described herein, are examples of non-transitory machine-readable storage media. In accordance with example implementations, the machine-readable storage media may be used for a variety of storage-related and computing-related functions. As examples, the memory devices may include semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

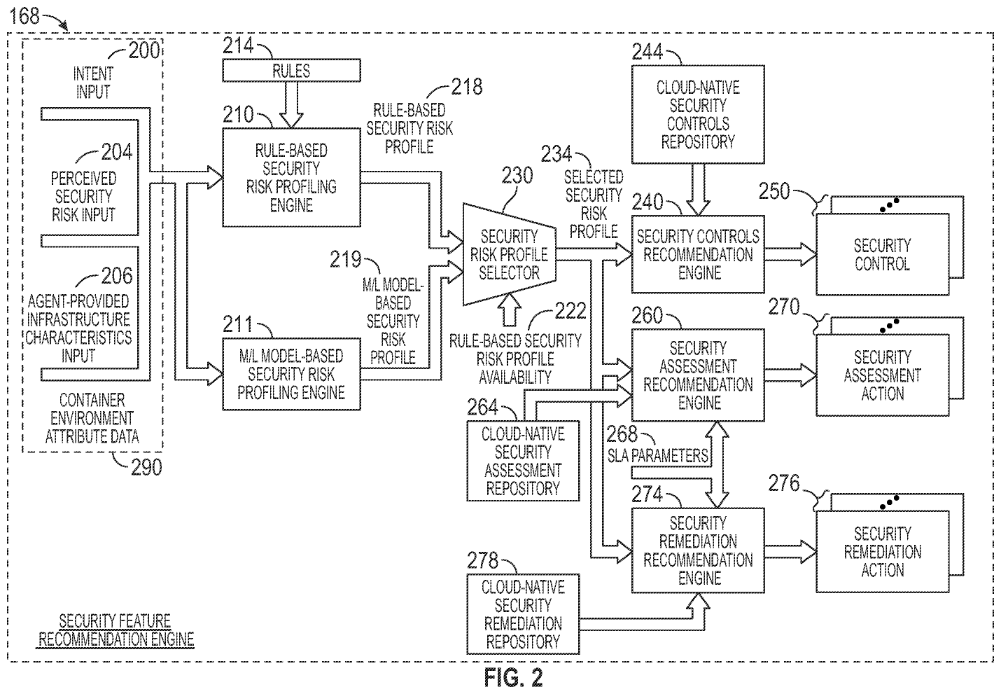

FIG. 2 depicts a block diagram of the security feature recommendation engine 168, in accordance with example implementations. Referring to FIG. 2, the recommendation engine 168 receives data representing container environment attribute data 290 that characterize a particular to-be-deployed container environment. The container environment attribute data 290 includes user-provided intent input 200. The intent input 200 represents an intent associated with the container environment.

The intent input 200 may represent an environmental context of the container environment. In accordance with some implementations, the environment context may be multi-dimensional in that the environment context may represent multiple environment-affiliated attributes associated with the container environment. In an example, the environment context may correspond to a geographical location of the infrastructure on which the container environment is deployed. In another example, the environment context may characterize the container environment as being hosted on a public cloud infrastructure or being hosted on a private infrastructure. In another example, the environment context may characterize a security environment for the container environment, such as whether the container environment is within a self-contained subnet or is in a self-contained subnet with a firewall. In another example, the environment context may characterize the physical security of the infrastructure hosting the container environment, such as the physical security imposed (e.g., building access control) for the infrastructure.

The intent input 200 may represent a multi-dimensional workload context of the container environment. In an example, the workload context may characterize a workload category, or type, handled by the container environment. For example, for a container environment that is associated with a continuous integration/continuous delivery (CI/CD) pipeline, the workload context may characterize the container environment as being associated with a particular stage of the CI/CD pipeline. In another example, the workload context may characterize the container environment as being associated with a particular category, or type, of application (e.g., a web application, a database access application, or a JENKINS automation server).

The intent input 200 may represent a multi-dimensional infrastructure context of the container environment. In an example, the infrastructure context may characterize the container environment as being deployed on a bare metal computer platform. In another example, the infrastructure context may characterize the container environment as being deployed in a virtual machine. In another example, the infrastructure context may characterize the container environment as being deployed in a virtual machine that is associated with a type one hypervisor that directly runs on the remote infrastructure. In another example, the infrastructure context may characterize the container environment as being deployed in a virtual machine that is associated with a type two hypervisor that runs on top of an operating system. In another example, the infrastructure context may characterize the container environment as having a light weight operating system. In another example, the infrastructure context may characterize a container privilege level (e.g., a user mode, privileged mode or root mode of the container operation) of the container environment. In another example, the infrastructure context may characterize whether the container environment uses unikernel virtualization.

In another example, the infrastructure context may characterize a type of storage virtualization that is used by the container environment. In another example, the infrastructure context may characterize a type of network virtualization that is used by the container environment. In another example, the infrastructure context may characterize the container environment as being associated with a particular data security compliance standard, such as the Payment Card Industry Data Security Standard (PCI DSS) or a standard associated with the Health Insurance Portability and Accountability Act (HIPAA).

The intent input 200 may represent an asset context of the container environment. Depending on the particular implementation, the asset context may be one dimensional or multi-dimensional. In an example, the asset context may characterize a value of the container environment. For example, the asset context may correspond to a user-specified assessment of an importance, or criticality, of the container environment. In an example, the asset context may represent one or multiple attributes of the container environment, from which an assessment may be made of the importance, or criticality, of the container environment.

The intent input 200 may represent a multi-dimensional cloud-native design context of the container environment. In an example, the cloud-native design context may characterize whether the container environment is an orchestrated container environment or is self-managed. In another example, the cloud-native design context may characterize compliance of the container environment with a cloud-based security standard, such as a Center for Internet Security (CIS) standard or a National Institute of Standards and Technology (NIST) cybersecurity framework standard.

The intent input 200 may characterize a multi-dimensional technical design context of the container environment. In an example, the technical design context may characterize whether the container environment has an external interface to the Internet. In another example, the technical design context may characterize one or multiple details of the container environment's software stack.

As also depicted in FIG. 2, in accordance with example implementations, the container environment attribute data 290 may include data other than the intent input 200. In an example, the security feature recommendation engine 168 may receive a perceived security risk input 204. The security risk input 204 represents a security risk profile classification that may be assigned by the customer associated with the container environment. In an example, the security risk input 204 may characterize the container environment as being perceived as belonging to a particular discretized security risk profile, such as a high security risk, a medium security risk or a low security risk. In another example, the security risk input 204 may characterize the container environment as being associated with a perceived security risk score (e.g., a security risk score in the range of 1 to 10).

As further depicted in FIG. 2, in accordance with example implementations, the container environment attribute data 290 may include input 206 that is provided by an agent that is deployed on the remote infrastructure upon which the container environment is to be deployed and which represents one or multiple attributes of the remote infrastructure. In an example, the input 206 may be provided by an infrastructure discovery service, such as the infrastructure discovery service 197 of FIG. 1. In an example, the agent may be a management agent that will manage compliance of the container environment with security policies after the container environment is deployed, such as the management agent 130 of FIG. 1. In another example, the agent may not correspond to a management agent that monitors compliance of the container environment with security policies. In an example, the input 206 may represent an infrastructure context of the container environment.

In accordance with example implementations, a rule-based security risk profiling engine 210 and a machine learning model-based security risk profiling engine 211 of the security feature recommendation engine 168 receives the inputs 200, 204 and 206. The rule-based security risk profiling engine 210 applies the inputs 200, 204 and 206 to a set of rules 214 for purposes of determining a rule-based security risk profile 218. In accordance with example implementations, the rules 214, in general, map certain combinations of the inputs 200, 204 and 206 to a particular rule-based security risk profile 218. In an example, the rule-based security risk profile may be a high security risk, a medium security risk or a low security risk. In accordance with further implementations, the security risk profile may have more or fewer than three security risk classifications. A rule 214, in general, may set forth a combinatorial logic expression that is evaluated based on at least some of the inputs 200, 204 and 206; and if the evaluated combinatorial expression is a Boolean TRUE, then the rule 214 associates the container environment with a particular security risk profile classification. In an example, the rules 214 may be derived from a knowledge base in which container environments were classified by human experts as being associated with certain security risks, and certain characteristics (used as inputs for the rules 214) were identified by the human experts as being reliable predictors of the security risks.

In an example, the intent input 200 may indicate that the container environment is a build infrastructure of a CI/CD pipeline. For this example, a particular rule 214 may classify the container environment as having a high security risk profile due to the relatively high risk of supply chain attacks.

In another example, the intent input 200 may represent that the container environment is a web application that does not have an external interface and is in a self-contained subnet with a firewall. For such a container environment, a rule 214 may classify the container environment as having a medium security risk profile.

In another example, the perceived security risk input 204 may classify the container environment as having a high security risk. For this example, a rule 214 may classify the container environment as having a high security risk profile, even though, as an example, other input (independently from the perceived security risk input 204) may have led to another rule 214 otherwise associating the container environment with a low security risk profile.

In another example, the perceived security risk input 204 may classify the container environment as having a low security risk. For this example, a rule 214 may classify, for example, the container environment as having a high security risk based on other context attributes represented by the intent input 200.

The rules 214 may, however, not cover some combinations of input. Stated differently, for a particular a set of inputs, none of the rules 214 may associate the set of inputs with a particular security risk profile (e.g., none of rules 214 may result in a Boolean TRUE result). In accordance with example implementations, for such cases, the security feature combination engine 168 relies on the machine learning model-based security risk profiling engine 211 to provide a machine learning model-based security risk profile 219.

In an example, the machine learning model-based security risk profile engine 211 may include one or multiple supervised classifiers that are trained using a classification algorithm. The training may involve, for example, the use of human experts to evaluate security risk profile classification for different sets of training data. In examples, the classification algorithm may be a decision tree algorithm or a random forest algorithm.

In accordance with some implementations, as an example, a security risk profile selector 230 selects the rule-based security risk profile 218 (to provide a selected security risk profile 234), if the rule-based security risk profiling engine 210 is able to classify the security risk based on the input 200, 204 and 206 using the rules 214. Otherwise, in accordance with example implementations, the rule-based security risk profiling engine 210 provides an indication 222 that the rule-based security risk profile 218 is unavailable. In response to this indicated unavailability, the security risk profile selector 230 selects the machine learning model-based security risk profile 219 (to provide the selected security risk profile 234). In another example, the security risk profile selector 230 may weight the profiles 218 and 219 and generate the selected security risk profile 234 responsive to the weighting. In another example, the security risk profile selector 230 may combine the profiles 218 and 219 in another manner to generate the selected security risk profile 234.

As depicted in FIG. 2, the security risk profile 234 is received as an input to a security controls recommendation engine 240 that provides one or more recommended security controls 250 for the container environment. The decision by the security controls recommendation engine 240 may be controlled, among other factors, by a policy mapping of the security risk profile 234 to a set of security controls. Moreover, the selected controls may also be constrained by features that are available for the remote infrastructure. In an example, for a cloud-based remote infrastructure, the security controls recommendation engine 240 may access a cloud native security controls repository 244 for such purposes as determining whether particular security controls can and/or cannot be implemented and various aspects of the security controls.

In an example, the security risk profile 234 may be a high security risk (e.g., the highest security risk profile). In an example, for a high security risk, the security controls recommendation engine 240 may recommend a certain security control 250 for network communications, such as the use of a secure hypertext transfer protocol secure (HTTPS) for network services. In another example, for a high security risk, the security controls recommendation engine 240 may recommend a certain security control 250 for communications with a baseboard management controller (BMC), such as a recommendation that intelligent platform management interface (IPMI) communications with the BMC should be disabled. In another example, for a high security risk, the security controls recommendation engine 240 may recommend a certain security control 250 for user management, such as a recommendation that a non-root user account exists for local administrator access. In another example, for a high security risk, the security controls recommendation engine 240 may recommend restricting the loading of container images to be signed images.

The security controls recommendation engine 240 may, in accordance with example implementations, recommend one or multiple security controls 250 based on the input 200, 204 and 206 in combination with the security risk profile 234. For example, for a high security risk, the security controls recommendation engine 240 may consider whether the intent input 200 (e.g., the asset context) classified the container environment as being of high importance, or critical. If so, then the security controls recommendation engine 240 may recommend a certain security control 250 for firmware services, such as recommending enablement of password for Unified Extensible Firmware Interface (UEFI) or Basic Input/Output System (BIOS) calls.

For a high security risk and a container environment that has been designated as being of high importance, the security controls recommendation engine 240 may recommend a certain security control 250 for the operating system, such as a strong password policy (e.g., a minimum password length of 14 characters). The security controls recommendation engine 240 may recommend different levels of security alerting and logging controls 250 for operating system events, based on the security risk profile.

In another example, for a high security risk, the security controls recommendation engine 240 may consider whether the intent input 200 (e.g., the environment context) classified the container environment as being in a corporate or enterprise environment. If so, the security controls recommendation engine 240 may recommend a certain security control 250 for logging, such as logging remote logging for bare metal hypervisor (e.g., an ESXi hypervisor) hosts. In another example, for a high security risk, the security controls recommendation engine 240 may consider whether the intent input 200 classified the container environment as being critical.

In another example, for a high security risk, the security controls recommendation engine 240 may consider whether the intent input 200 (e.g., a cloud-native design context) classified the container environment as being an orchestrated environment. If so, the security controls recommendation engine may recommend a security control 250 that limits access to the orchestrator's control plane, such as a restriction to limit use by the control plane to a root only file system. In an example of another security control 250 for an orchestrated container environment that has a high security risk, the security controls recommendation engine 240 may recommend a security control 250 that limits application processes to run as root processes.

As depicted in FIG. 2, in accordance with example implementations, the security risk profile 234 may also be received as an input to a security assessment recommendation engine 260 that provides one or multiple recommended security assessment actions 270 for the container environment based on the profile 234. The security assessment recommendation engine 260 may also consider additional input other than and in addition to the security risk profile 234, such as service level agreement (SLA) parameters and the inputs 200, 204 and 206. In an example, for medium or high security risks, the security assessment recommendation engine 260 may recommend, as a security assessment action 270, container image scans responsive to a threat intelligence feed announcing a new container vulnerability. In another example, the security assessment recommendation engine 260 may recommend, as a security assessment action 270, that container images are to be scanned at a certain frequency, with the recommended frequency being dependent on such factors as the security risk and possibly one or more other factors (e.g., whether the container environment is considered to be critical and an infrastructure context of the container environment). In another example, the security assessment recommendation engine 260 may base a minimum rate for a set of recommended scans on a minimum frequency specified by the SLA. In another example, the security assessment recommendation engine 260 may recommend, as a security assessment action 270, that container images are to be scanned in response to specified events (e.g., a privileged login or a certain anomaly event). The security assessment recommendation engine 260 may identify, for some security assessment actions 270, particular event or events to trigger scans based on the security risk profile 234 and possibly one or multiple other factors (e.g., factors associated with infrastructure, asset or environment contexts of the container environment).

As depicted in FIG. 2, the security risk profile 234, in accordance with example implementations, may be received as an input to a security remediation recommendation engine 274 that provides one or multiple recommended security remediation actions 276 for the container environment. In addition to considering the security risk profile 234, the security remediation recommendation engine 274 may consider additional inputs other than or in addition to the security risk profile 234, such as SLA parameters 268 and/or the inputs 200, 204 and 206. In an example, the security remediation recommendation engine 274 may recommend security remediation actions 276 based on SLA parameters 268 in combination with the determined security risk. In an example, an SLA may specify 30 days as being the maximum time to fix a critical issue, and the security remediation recommendation engine 274 may recommend corresponding remediation actions 276 that cure identified critical issues within the 30 days. In another example, an SLA may specify a maximum time to fix a highly important (but less than critical) issue is 60 days, and the security remediation recommendation engine 274 may recommend remediation actions 276 that identify high important issues and specify a maximum time of 60 days to cure the issues.

In another example, the security remediation recommendation engine 274 may recommend certain remediation actions 276 to address certain events. In an example, the security remediation recommendation engine 274 may recommend a security remediation action 276 to shut down a worker node of a container environment responsive to a particular event (e.g., a certain number of unsuccessful password attempts, a detected security vulnerability, detected tampering, a reset event or other event) occurring. In another example, the security remediation recommendation engine 274 may recommend a security remediation action 276 to send an alert message to a system administrator in response to the occurrence of a particular event. For a given recommended security remediation action 276, the security remediation recommendation engine 274 may select the trigger for the action 276 based on any of a number of different criteria, such as one or multiple of the following: the security risk for the container environment, a particular context (as determined by the intent input 200), the perceived security risk (as represented by the input 204) and/or agent-provided infrastructure characteristics (as represented by the input 206).

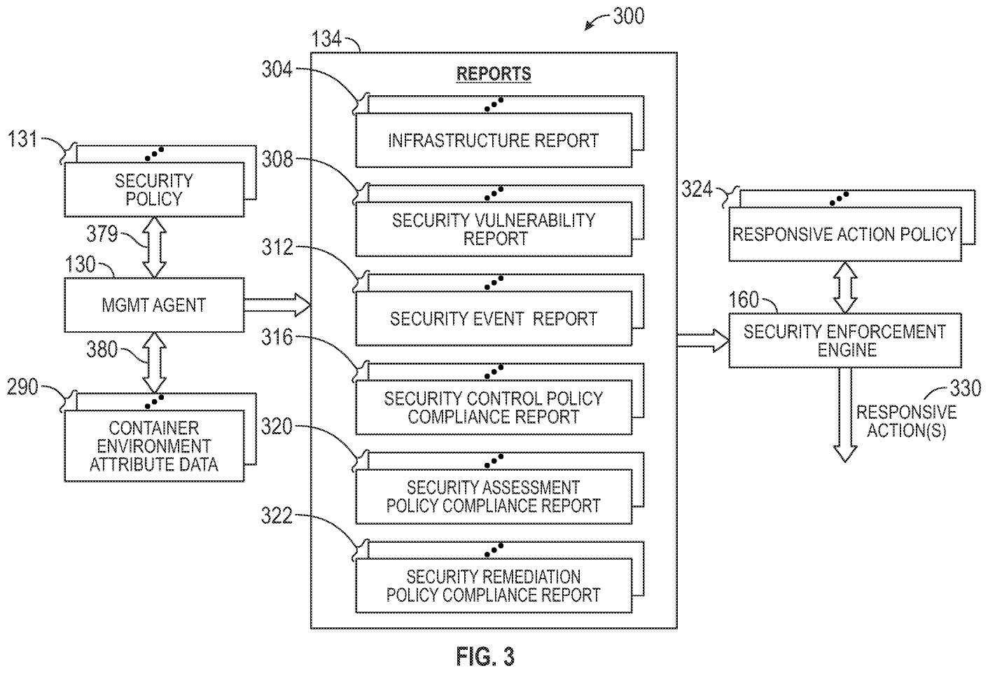

FIG. 3 depicts a subsystem 300 to manage security features of a container environment, in accordance with example implementations. Referring to FIG. 3, a management agent 130, which may be deployed on a remote infrastructure with a particular container environment, sends reports 134 to a security enforcement engine 160. Responsive to the reports 134, the security enforcement engine 160 may perform one or multiple responsive actions 330 based on an appropriate responsive action policy 324. As depicted in FIG. 3, the reports 134 may include reports that represent whether the container environment is in compliance with corresponding security policies, such as a security control policy compliance report 316 (representing any non-compliance with security controls that are set forth in a security control policy), a security assessment policy compliance report 320 (representing any non-compliance with assessment actions that are set forth in a security assessment policy) and a security remediation policy compliance report 322 (representing any non-compliance with remediation actions that are set forth in a security remediation policy). For these purposes, the management agent 130 may check container environment attribute data 290 against security polices 131, as depicted at 379 and 380.

As depicted in FIG. 3, in accordance with some implementations, the remote management agent 130 may send reports other than security policy compliance reports. For example, the reports 134 may include one or multiple infrastructure reports 304 that contain data representing details of the remote infrastructure. The reports 134 may contain one or multiple security vulnerability reports 308 that contain data representing details about any detected security vulnerabilities (e.g., vulnerabilities confirmed after a scan triggered by threat intelligence). The reports 134 may include one or multiple security event reports 312 that contain details about any security-related events (e.g., a detected signature associated with a malevolent actor, a behavior pattern consistent with a security attack, communication with an IP address associated with a rogue actor, suspicious elevated privileges or other events).

The security enforcement engine 160 may apply one or multiple responsive action policies 324 for purposes of identifying an action to be taken in response to the reports. In an example, a particular responsive policy 324 may be associated with a compliance report 316, 320 or 322 and specify one or multiple actions (e.g., alert reporting, container environment shutdown, container reconfiguring, marking nodes as unhealthy, stopping a node or container pod, other action) to be taken by the security enforcement engine 160 when specified non-compliances occur. In a similar manner, one or multiple other responsive action policies 324 may be triggered by events or conditions that are represented by data in the reports 304, 308 and 312; and these policies 324 may actions to be taken by the security enforcement engine 160 in response to the events or conditions. In accordance with some implementations, the infrastructure reports 304 may also be processed by an infrastructure discovery engine, such as the infrastructure discovery engine 164 of FIG. 1.

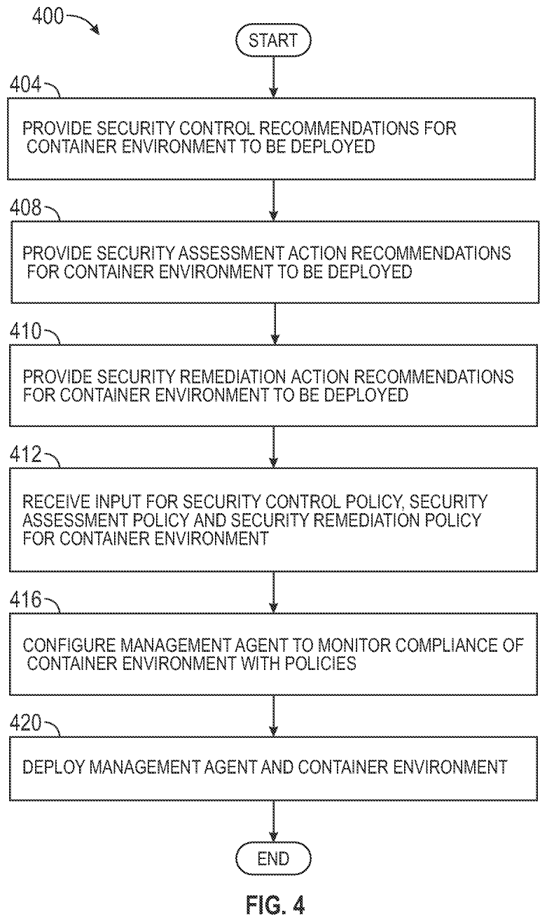

FIG. 4 depicts an example process 400 that may be used to deploy a container environment and a management agent on a remote infrastructure, in accordance with some implementations. In an example, the process 400 may correspond to actions that are taken by the security feature recommendation engine 168 (FIG. 1) and the deployment engine 166 (FIG. 1) for purposes of providing the security feature recommendation service 193 (FIG. 1) and the deployment service 195 (FIG. 1), respectively. For the example implementation depicted in FIG. 4, the management agent has not been deployed to the remote infrastructure prior to the deployment of the container environment.

Referring to FIG. 4, the process 400 includes providing (block 404) security control recommendations, providing (block 408) security assessment action recommendations and providing (block 412) security remediation action recommendations for a container environment that is to be deployed to a remote infrastructure. The recommendations may be based, at least in part on intent input that is provided by a user (e.g., a software developer or a system administrator) and describes an intent for the container environment. The recommendations may take into account one or multiple other criteria, such as user-provided perceived security risk of the container environment and SLA parameters. Moreover, the recommendations may determine a security risk for the container environment based on the input and consider the security risk itself as an input for the recommendations.

Based the recommendations, a user (e.g., a software developer or a system administrator) may choose to implement, in the container environment, one or multiple of the recommended security controls, security assessment actions and security remediation actions. More the user may choose to not implement certain recommendations, and the user may choose different and/or modified security controls, security assessment actions and/or security remediation actions. Regardless of the particular security controls, security assessment actions and security remediation actions implemented for the container environment, the user may provide, in accordance with block 412, input that represents that security policies that the user wants to be monitored for compliance. These security policies may or may not include all of the security features that are implemented for the container environment.

Pursuant to block 416, the process 400 includes configuring a management agent to monitor compliance with the security policies. The management agent and the container environment are then deployed to the remote infrastructure, pursuant to block 420.

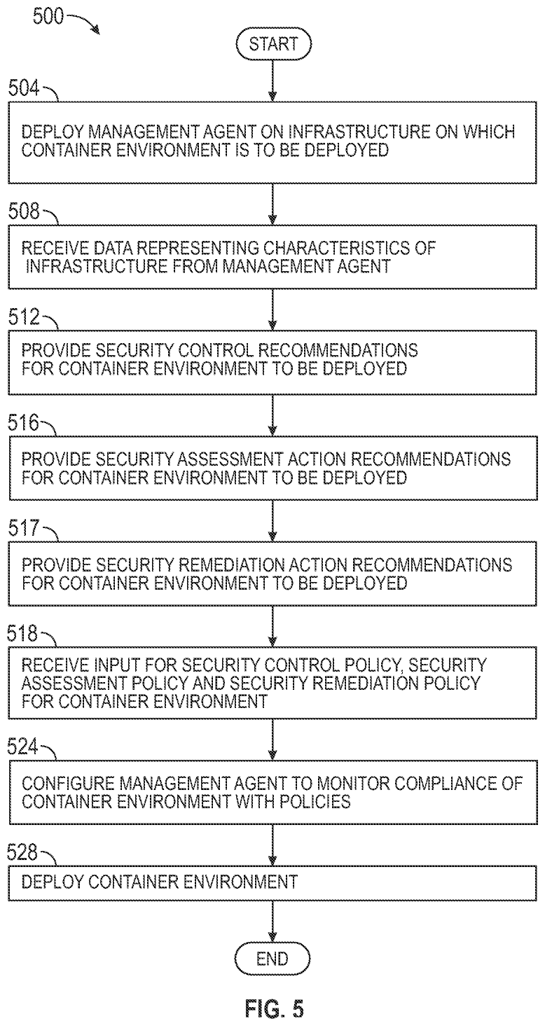

FIG. 5 depicts an example process 500 that may be used to first deploy a remote management agent on a remote infrastructure, use the remote management agent to discover and provide information about the remote infrastructure and then use this information for purposes of recommending security features for a to-be-deployed container environment. In an example, the process 500 may correspond to actions that are taken by the security feature recommendation engine 168 (FIG. 1) and the deployment engine 166 (FIG. 1) for purposes of providing the security feature recommendation service 193 (FIG. 1) and the deployment service 195 (FIG. 1), respectively.

Referring to FIG. 5, the process 500 includes deploying (block 504) a management agent on a remote infrastructure on which a container environment is to be deployed. In an example, the management agent may have been deployed in conjunction a previously-deployed container environment, and the management agent may, for example, monitor compliance of the container environment with one or multiple security policies. In another example, the management agent may be solely associated with the to-be-deployed container environment, but the management agent may be deployed first for purposes of gathering and reporting information about the remote infrastructure.

Pursuant to block 508, the process 500 includes receiving data representing attributes, or characteristics, of the remote infrastructure from the remote management agent. In an example, the characteristics may be used to assemble a multi-dimensional infrastructure context for the remote infrastructure. The process 500 next includes providing (block 512) security control recommendations, providing (block 516) security assessment action recommendations and providing (block 517) security remediation action recommendations for a container environment that is to be deployed to a remote infrastructure. A user may then provide, in accordance with block 518, input that represents that security policies that the user wants to be monitored for compliance. Pursuant to block 524, the process 500 includes configuring the already deployed remote management agent to monitor compliance with the security policies. The container environment is then deployed to the remote infrastructure, pursuant to block 528.

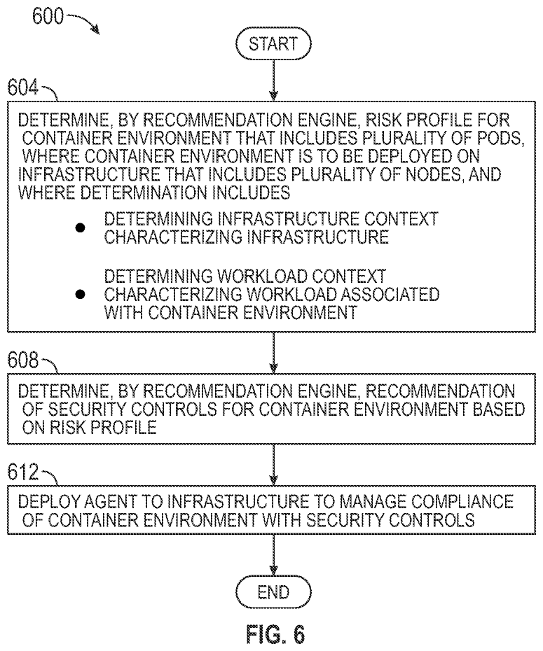

Referring to FIG. 6, in accordance with example implementations, a process 600 includes determining (block 604), by a recommendation engine, a security risk profile for a container environment. The container environment includes a plurality of pods that are to be deployed on an infrastructure that includes a plurality of nodes. Determining the security risk profile includes determining an infrastructure context characterizing the infrastructure and determining a workload context characterizing a workload associated with the container environment. In an example, the security risk profile may be a classification of the container environment according to a particular risk level. In an example, a security risk profile may be a classification of the container environment as belonging to a high risk, medium risk or low risk.

In an example, determining the security risk profile may consider an intent input that represents an intent for the container environment. In an example, determining the security risk profile may be consider a user provided perceived security risk of the container environment. In an example, determining the security risk profile may be consider details about the infrastructure, which is provided by a remote agent that is deployed on the infrastructure.

In an example, the container environment may be an orchestrated cluster of worker nodes. In an example, each worker node may include one or multiple container pods. In another example, the container environment may include one or multiple self-managed containers. In another example, the container environment may be a multi-cluster environment. In another example, the container environment may be a multi-tenant environment.

In an example, the infrastructure context may be a multi-dimensional context that represents multiple infrastructure-related attributes of the infrastructure on which the container environment is deployed. In an example, the infrastructure context may characterize the container environment as being deployed on a bare metal computer platform. In another example, the infrastructure context may characterize the container environment as being deployed in a virtual machine. In another example, the infrastructure context may characterize the container environment as being deployed in a virtual machine associated with a type one hypervisor that directly runs on the remote infrastructure. In another example, the infrastructure context may characterize the container environment as being deployed in a virtual machine associated with a type two hypervisor that runs on top of an operating system.

In another example, the infrastructure context may characterize the container environment as having a light weight operating system. In another example, the infrastructure context may characterize a container privilege level of the container environment. In another example, the infrastructure may characterize whether the container environment uses unikernel virtualization. In another example, the infrastructure context may characterize a type of storage virtualization used by the container environment. In another example, the infrastructure context may characterize a type of network virtualization used by the container environment. In another example, the infrastructure context may characterize the container environment as being associated with a particular data security compliance standard.

In an example, the workload context may characterize a workload category, or type, handled by the container environment. In accordance with some implementations, the workload context may be a multi-dimensional context that indicates multiple attributes associated with the container environment's workload. In an example, the workload context may characterize the container environment as being associated with a particular stage of the CI/CD pipeline. In another example, the workload context may characterize the container environment as being associated with a particular category, or type, of application.

Pursuant to block 608, the process 600 includes determining, by the recommendation engine, a recommendation of security controls for the container environment based on the risk profile. In an example, a security control may be a minimum password length for an operating system. In another example, a security control may be a password control for UEFI or BIOS access. In another example, a security control may be network security protocol, such as an HTTPS protocol. In another example, a security control may be a prohibition of using a particular communication protocol, such as the disabling IPMI protocol communications with a BMC. In another example, a security control may be the imposition of remote logging.

The process 600 includes deploying (block 612) an agent to the infrastructure to manage compliance of the container environment with the security control. In an example, the agent may be deployed with the container environment. In an example, the agent may be deployed before the container environment. In an example, the agent may be configured with a security policy to monitor whether the container environment complies with the security policy. In an example, the security policy may specify a recommended security control.

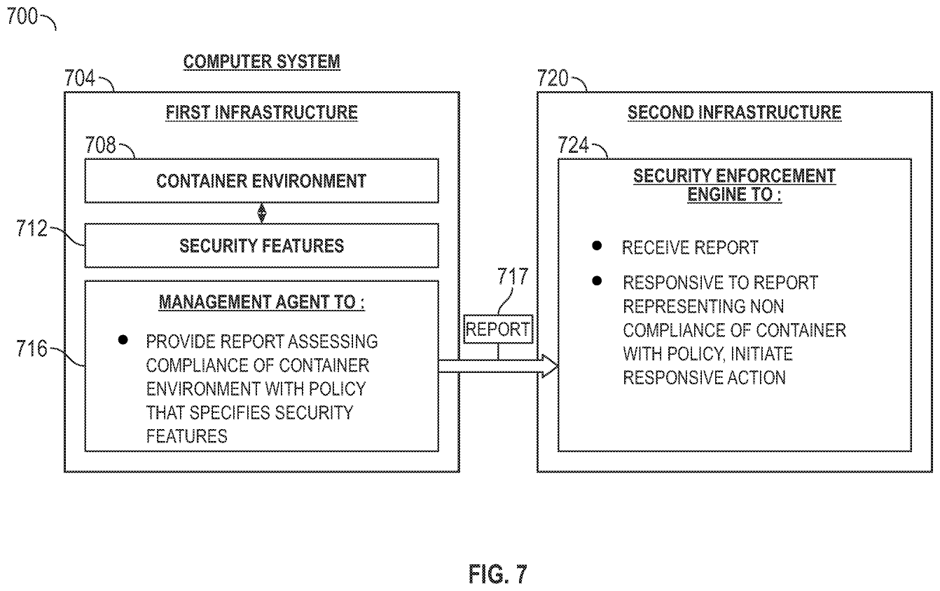

Referring to FIG. 7, in accordance with example implementations, a computer system 700 includes a management agent 716 and a security management engine 724. The management agent 716 is hosted on a first infrastructure 704 that also hosts a container environment 708. The management agent 716 is to provide a report assessing compliance of the container environment 708 with a security policy. The security policy includes a set of security features. In an example, the security features may include one or multiple security controls, security assessment actions or security remediation actions.

In an example, the container environment may be an orchestrated cluster of worker nodes. In an example, each worker node may include one or multiple container pods. In another example, the container environment may include one or multiple self-managed containers. In another example, the container environment may be a multi-cluster environment. In another example, the container environment may be a multi-tenant environment.

In an example, the security features may include security controls. In an example, a security control may be a minimum password length for an operating system. In another example, a security control may be a password control for UEFI or BIOS access. In another example, a security control may be network security protocol, such as an HTTPS protocol. In another example, a security control may be a prohibition of using a particular communication protocol, such as the disabling IPMI protocol communications with a BMC. In another example, a security control may be the imposition of remote logging.

In an example, the security features may include security assessment actions. In an example, a security assessment action may be container image scan responsive to a threat intelligence feed announcing a new container vulnerability. In another example, a security assessment action may be a container image scanned, wherein the scanning occurring at a certain frequency. In an example, the frequency may depend on a security risk of the container environment. In an example, the frequency may depend on an SLA. In an example, a security assessment action may be container image scan responsive to a particular event.

The security management engine 724 is hosted on a second infrastructure 720, which is remote from the first infrastructure 704. The security management engine 724 is to receive the report, and responsive to the report representing non-compliance of the container with the security policy, initiate a responsive action. In an example, a responsive action may include sending an alert message. In another example, a responsive action may include stopping the container environment. In another example, a responsive action may be marking a worker node of the container environment as being unhealthy. In another example, a responsive action may include stopping a container or a container pod of the container environment. In another example, a responsive action may include scanning a container image. In another example, a responsive action may include reconfiguring the container environment.

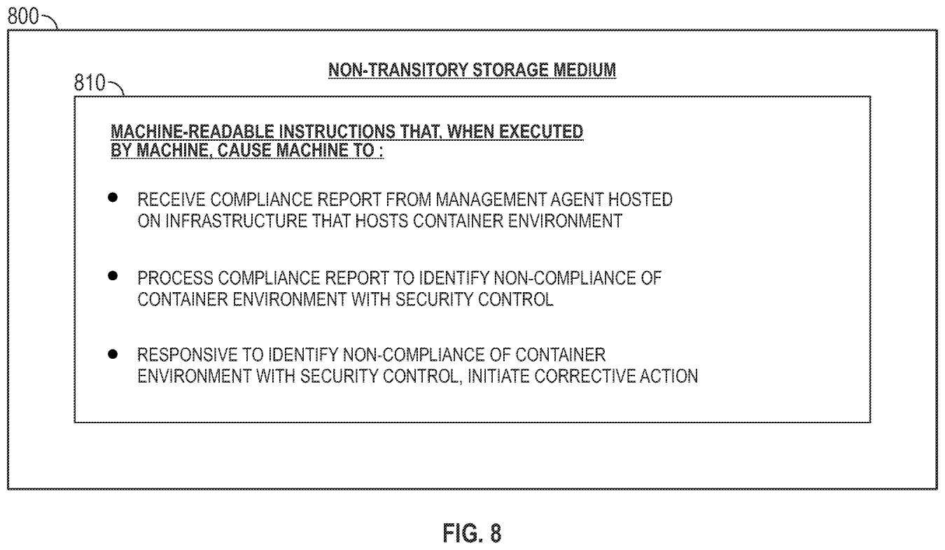

Referring to FIG. 8, in accordance with example implementations, a non-transitory storage medium 800 stores machine-readable instructions 810. The instructions 810, when executed by a machine that is associated with a cloud service, cause the machine to receive a compliance report from a management agent that is hosted on an infrastructure that hosts a container environment.

In an example, the container environment may be an orchestrated cluster of worker nodes. In an example, each worker node may include one or multiple container pods. In another example, the container environment may include one or multiple self-managed containers. In another example, the container environment may be a multi-cluster environment. In another example, the container environment may be a multi-tenant environment.

In an example the compliance report may contain data that represents whether the container environment complied with a security policy. In an example, the security policy may specify security controls for the container environment. In another example, the security policy may specify security assessment actions for the container environment. In another example, the security policy may specify security remediation actions for the container environment.

The instructions 810, when executed by the machine, further cause the machine to process the compliance report to identify non-compliance of the container environment with a security control policy. The instructions 810, when executed by the machine, further cause the machine to, responsive to identifying non-compliance of the container environment with the security policy, initiate a corrective action.

In an example, a corrective action may include sending an alert message. In another example, a corrective action may include stopping the container environment. In another example, a corrective action may be marking a worker node of the container environment as being unhealthy. In another example, a corrective action may include stopping a container or a container pod of the container environment. In another example, a corrective action may include scanning a container image. In another example, a corrective action may include reconfiguring the container environment.

In accordance with example implementations, determining the security risk profile further includes applying, by the recommendation engine, the infrastructure context and the workload context to a rules-based classifier to determine the security risk profile. A particular advantage is that a container environment may be properly secured, even for an elastic infrastructure and ephemeral-orchestrated workloads.

In accordance with example implementations, determining the security risk profile further includes, responsive to application of the infrastructure context and the workload context to the rules-based classifier not providing a classification, applying, by the recommendation engine, the infrastructure context and the workload context to a machine learning-based classifier to determine the security risk profile. A particular advantage is that a container environment may be properly secured, even for an elastic infrastructure and ephemeral-orchestrated workloads.

In accordance with example implementations, determining the recommendation of the security policy includes determining a network service security control, a chassis security control, or a user management security control for the container environment. A particular advantage is that a container environment may be properly secured, even for an elastic infrastructure and ephemeral-orchestrated workloads.

In accordance with example implementations, determining the security risk profile further includes receiving, by the recommendation engine, a perceived security risk of the container environment provided as a user input. Determining the security risk profile further includes determining the profile based on the perceived security risk. A particular advantage is that a container environment may be properly secured, even for an elastic infrastructure and ephemeral-orchestrated workloads.

In accordance with example implementations, determining the security risk profile further includes receiving, by the recommendation engine, intent parameters for the container environment provided as user input. The intent parameters represent at least one of an infrastructure for the container environment or a workload for the container environment. A particular advantage is that a container environment may be properly secured, even for an elastic infrastructure and ephemeral-orchestrated workloads.

In accordance with example implementations, deploying the agent includes deploying the agent before the deployment of the container environment. Determining the infrastructure context includes receiving, by the recommendation engine, input from the agent representing characteristics of the infrastructure. A particular advantage is that a container environment may be properly secured, even for an elastic infrastructure and ephemeral-orchestrated workloads.

In accordance with example implementations, deploying the agent includes deploying the agent after determination of the recommendation of the security policy. A particular advantage is that a container environment may be properly secured, even for an elastic infrastructure and ephemeral-orchestrated workloads.

In accordance with example implementations, a recommendation of a security assessment policy for the container environment is determined based on the security risk profile. A particular advantage is that a container environment may be properly secured, even for an elastic infrastructure and ephemeral-orchestrated workloads.

In accordance with example implementations, the security assessment policy specifies an action to evaluate the container environment for a security vulnerability or a security intrusion. The security assessment policy specifies a trigger to initiate the action. A particular advantage is that a container environment may be properly secured, even for an elastic infrastructure and ephemeral-orchestrated workloads.

In accordance with example implementations, a recommendation of a security issue remediation policy is determined for the container environment based on the security risk profile. A particular advantage is that a container environment may be properly secured, even for an elastic infrastructure and ephemeral-orchestrated workloads.

In accordance with example implementations, the security issue remediation policy specifies an action to respond to a detected security vulnerability or a security intrusion for the container environment. The security issue remediation policy specifies a condition to initiate the action. A particular advantage is that a container environment may be properly secured, even for an elastic infrastructure and ephemeral-orchestrated workloads.

In accordance with example implementations, determining the infrastructure context includes determining whether the container environment is hosted on a bare metal machine or hosted on a virtual machine. A particular advantage is that a container environment may be properly secured, even for an elastic infrastructure and ephemeral-orchestrated workloads.

In accordance with example implementations, determining the infrastructure context includes determining whether the container environment is associated with a data security standard. A particular advantage is that a container environment may be properly secured, even for an elastic infrastructure and ephemeral-orchestrated workloads.

In accordance with example implementations, determining the workload context includes identifying a stage of a continuous integration/continuous development (CI/CD) pipeline associated with the container environment. A particular advantage is that a container environment may be properly secured, even for an elastic infrastructure and ephemeral-orchestrated workloads.

In accordance with example implementations, determining the infrastructure context includes determining a cybersecurity framework that is associated with the infrastructure. A particular advantage is that a container environment may be properly secured, even for an elastic infrastructure and ephemeral-orchestrated workloads.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
determining, by a recommendation engine, a security risk profile for a container environment comprising a plurality of pods to be deployed on an infrastructure comprising a plurality of nodes, wherein determining the security risk profile comprises:
determining an infrastructure context characterizing the infrastructure; and
determining a workload context characterizing a workload associated with the container environment;
determining, by the recommendation engine, a recommendation of a security policy for the container environment based on the security risk profile, wherein the security policy comprises a security control; and
deploying an agent to the infrastructure to manage compliance of the container environment with the security control.

2. The method of claim 1, wherein determining the security risk profile further comprises applying, by the recommendation engine, the infrastructure context and the workload context to a rules-based classifier to determine the security risk profile.

3. The method of claim 2, wherein determining the security risk profile further comprises, responsive to application of the infrastructure context and the workload context to the rules-based classifier not providing a classification, applying, by the recommendation engine, the infrastructure context and the workload context to a machine learning-based classifier to determine the security risk profile.

4. The method of claim 1, wherein determining the recommendation of the security policy comprises determining a network service security control, a chassis security control or a user management security control for the container environment.

5. The method of claim 1, wherein determining the security risk profile further comprises:
receiving, by the recommendation engine, a perceived security risk of the container environment provided as a user input; and
determining the security risk profile based on the perceived security risk.

6. The method of claim 1, wherein determining the security risk profile further comprises:
receiving, by the recommendation engine, intent parameters for the container environment provided as user input, wherein the intent parameters represent at least one of an infrastructure for the container environment or a workload for the container environment.

7. The method of claim 1, wherein:
deploying the agent comprises deploying the agent before the deploying of the container environment; and
determining the infrastructure context comprises receiving, by the recommendation engine, input from the agent representing characteristics of the infrastructure.

8. The method of claim 1, wherein deploying the agent comprises deploying the agent after determination of the recommendation of the security policy.

9. The method of claim 1, further comprising determining, by the recommendation engine, a recommendation of a security assessment policy for the container environment based on the security risk profile.

10. The method of claim 9, wherein:
the security assessment policy specifies an action to evaluate the container environment for a security vulnerability or a security intrusion; and
the security assessment policy specifies a trigger to initiate the action.

11. The method of claim 1, further comprising determining, by the recommendation engine, a recommendation of a security issue remediation policy for the container environment based on the security risk profile.

12. The method of claim 1, wherein:
the security issue remediation policy specifies an action to respond to a detected security vulnerability or a security intrusion for the container environment; and
the security issue remediation policy specifies a condition to initiate the action.

13. The method of claim 1, wherein determining the infrastructure context comprises determining whether the container environment is hosted on a bare metal machine or hosted on a virtual machine.

14. The method of claim 1, wherein determining the infrastructure context comprises determining whether the container environment is associated with a data security standard.

15. The method of claim 1, wherein determining the workload context comprises identifying a stage of a continuous integration/continuous development (CI/CD) pipeline associated with the container environment.

16. The method of claim 1, wherein determining the infrastructure context comprises determining a cybersecurity framework associated with the infrastructure.

17. A computer system comprising:
a management agent hosted on a first infrastructure that hosts a container environment, wherein the management agent to provide a first report assessing compliance of the container environment with a security control policy specifying a set of security features for the container environment; and
a security management engine hosted on a second infrastructure remote from the first infrastructure, wherein the security management engine to:
receive the first report; and
responsive to the first report representing non-compliance of the container environment with the security policy, initiate a first responsive action.

18. The computer system of claim 17, wherein:
the management agent to further provide a second report assessing compliance of the container environment with a security issue assessment policy; and
the security management engine to further:
receive the second report; and
responsive to the second report representing non-compliance of the container environment with the security issue assessment policy, initiate a second remediation action.

19. A non-transitory storage medium to store machine-readable instructions that, when executed by a machine associated with a cloud service, cause the machine to:
receive a first compliance report from a management agent hosted on an infrastructure that hosts a container environment;
process the second compliance report to identify non-compliance of the container environment with a security control policy; and
responsive to identifying non-compliance of the container environment with the security control policy, initiate a first corrective action.

20. The storage medium of claim 19, wherein the instructions, when executed by the machine, further cause the machine to:
receive a second compliance report from the management agent;
process the second compliance report to identify non-compliance of the container environment with a security issue remediation policy; and
responsive to identifying non-compliance of the container environment with the security issue remediation policy, initiate a second corrective action.
